(19) United States
(12) Patent Application Publication
(10) Pub. No.: US 2003/0115122 A1
(43) Pub. Date: Jun. 19, 2003

(54) System and method for alert processing and delivery

(76) Inventors: Michael Sol Slater, Staten Island, NY (US); Mark Anthony DiStaulo, Hoboken, NJ (US); Charles N. Johnston, Fanwood, NJ (US); Phillip Koh-Kwe Hsu, Ho Ho Kus, NJ (US)

Correspondence Address: LESLIE GLADSTONE RESTAINO, BROWN RAYSMAN MILLSTEIN & STEINER LLP, 55 MADISON AVENUE, 4TH FLOOR, MORRISTOWN, NJ, 07960, US

(21) Appl. No.: 10/352,708

(22) Filed: Jan. 27, 2003

Related U.S. Application Data
(63) Continuation-in-part of application No. 09/687,892, filed on Oct. 13, 2000.

(51) Int. Cl. G06F 17/60

(52) U.S. Cl. 705/35

(57) ABSTRACT

The present invention comprises a system and method for processing and delivering one or more financial alerts. The method of the present invention comprises normalizing financial data received from one or more financial data sources to generate a financial alert. A relevance engine processes the financial alert according to a client profile to determine one or more delivery destinations for the financial alert. Based on the processing step, the financial alert is delivered to the delivery destination.

The system and method of the present invention electronically provides users with financial updates regarding order status, a user's specific portfolio and general financial information. Moreover, the present invention provides for the delivery of messages in accordance with predefined customer preferences, such as specific account information, specific financial information or customer defined formatting of the message, e.g., detailed or message summary. Financial advisors are provided with functionality that allows for the monitoring of messages sent to customers, as well as editing and/or adding information to that contained within the message.

### CROSS-REFERENCE TO RELATED APPLICATIONS

This application is related to, and is a continuation-in-part of, patent application Ser. No. 09/687,892, titled “SYSTEM AND METHOD FOR DELIVERING A FINANCIAL MESSAGE”, filed Oct. 13, 2000, which is hereby incorporated by reference in its entirety into this application.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### BACKGROUND OF THE INVENTION

1. Field of the Invention

The invention disclosed herein relates generally to notification systems. More particularly, the present invention relates to systems and methods for processing alerts relating to one or more given states or activities and delivering the alerts to one or more destination devices.

2. Description of the Related Art

New client demands, technological innovations and tighter regulatory controls are constantly changing the landscape of the money management industry. The evolution of the Internet and the development of new technological capabilities are pressing security houses to develop method that facilitate the need for efficient trading. In traditional asset management, customers are advised by financial advisors who interact with traders to execute security trades on behalf of customers. The ability of a customer and their financial advisor to have current information regarding the customer's specific portfolio, as well as general market conditions, often makes the difference between profitability and unprofitability.

Heretofore, many have attempted to provide such information to customers through various means. One such example is shown in U.S. Pat. No. 5,872,921 to Zahariev, et al., which discusses a system for analyzing a large data stream by applying time slices to create successive finite feed records that are compared to stored criteria for significance. U.S. Pat. No. 5,893,091 to Hunt describes a system for electronically distributing information to users based on predefined criteria.

None of the references that comprise the related art, however, teach a system and method for electronically providing users with financial updates regarding: order status, a user's specific portfolio and general financial information. Moreover, none of the references that comprise the related art teach the delivery of messages in accordance with predefined customer preferences, such as specific account information, specific financial information, customer defined formatting of the message, e.g., detailed or message summary. The related art also fails to disclose a system and method that allows internal users, e.g., financial advisors, to monitor messages sent to customers, as well as edit and/or add information to that contained within the message.

There is thus a need for systems and methods for delivering financial information that overcomes the limitations of the current state of the art.

### SUMMARY OF THE INVENTION

The present invention presents a novel system and method for processing and delivering alerts, specifically to delivering alerts comprising financial data to remote devices. Although the present invention is contemplated as being deployed in a financial setting, other deployment environments are contemplated as falling within the scope of the invention as one skilled in the art may readily adapt the structures and processes described herein to a variety of environments.

The method of the present invention for processing and delivering a financial alert comprises normalizing financial data received from one or more financial data sources to generate an alert. A relevance engine processes the alert according to a client profile to determine a delivery destination for the financial alert. Based on the client profile information, the alert is delivered to the destination device. In addition to the destination device, the alert may be delivered to a persistent inbox that is capable of being accessed over a network. When the client accesses the persistent inbox, such as through the use of web browser software executing on a personal computer connected to the Internet, the alert is presented to the client.

Financial alerts that are delivered to clients may be routed to a financial advisor. Alternatively, a copy of an alert delivered to a client is routed to a financial advisor associated with the client. The alert may be reviewed to ensure the financial data that comprises the alert adheres to relevant compliance regulations, which is typically conducted prior to delivery of the alert to a client, although this is not a requirement. Accordingly, a financial advisor may edit the alert in order to ensure that compliance regulations are adhered to. The financial advisor may additionally add supplemental information to the alert that is being transmitted to a client, for example, in order to provide enhanced financial information, assist the client in deciphering the financial information, or explaining the impact of the financial information on one or more of the client's holding.

The alert may be delivered to a variety of destination devices that may be defined by the client or a financial advisor associated with the client. The alert may also be delivered to a plurality of destination devices in a substantially simultaneous fashion. Both edited and non-edited alerts may be transmitted in this fashion. According to various embodiments of the invention, exemplary destination devices include one or more of cellular telephone handsets, paging devices and handheld computing devices such as personal digital assistants (PDA). A client or financial advisor who subscribes to receive one or more given alerts may receive the alert in its entirety or may opt to receive only a summary of the financial data that comprises the alert. This is especially useful in situations where the destination device connects to a distribution network over a low bandwidth connection.

The method of the present invention comprises collecting client preference information for inclusion in a client profile, which may be used to define how the method of the present invention is executed vis-a-vis a given user. The delivery of alerts to a destination device may be tracked to calculate statistics regarding the tracked information, for example, which clients and financial advisors make the most use of the present invention. Furthermore, the processing of financial data may be based, in whole or in part, on the financial transactions executed by the client.

Additional aspects of the present invention will be apparent in view of the description that follows.

### BRIEF DESCRIPTION OF THE DRAWINGS

The invention is illustrated in the figures of the accompanying drawings which are meant to be exemplary and not limiting, in which like references refer to like or corresponding parts, and in which:

FIG. 1 is a block diagram presenting a configuration of the interaction of the hardware and software components for processing and delivering alerts according to one embodiment of the present invention;

FIG. 2 is a block diagram presenting a configuration of the hardware and software components for processing and delivering alerts according to another embodiment of the present invention;

FIG. 3 is a block diagram presenting a detailed view of the transport queue for delivering alerts between various stages of the architecture according to one embodiment of the present invention;

FIG. 4 is a flow diagram presenting a method for retrieving an alert from a transport queue, processing the alert and delivering the alert to an outbox transport queue according to one embodiment of the invention;

FIG. 5 is a flow diagram presenting a process for automating the cleanup of a user's inbox according to one embodiment of the invention;

FIG. 6 is a flow diagram presenting a process for archiving alerts that have been marked for deletion by the inbox cleansing process according to one embodiment of the present invention;

FIG. 7 is a flow diagram presenting a process for manually subscribing to alerts according to one embodiment of the invention;

FIG. 8 is a flow diagram presenting a process for delivering alerts according to one embodiment of the invention; and

FIG. 9 is a screen diagram presenting an interface for generating manual alerts according to one embodiment of the invention.

### DETAILED DESCRIPTION OF THE PREFERRED EMBODIMENTS

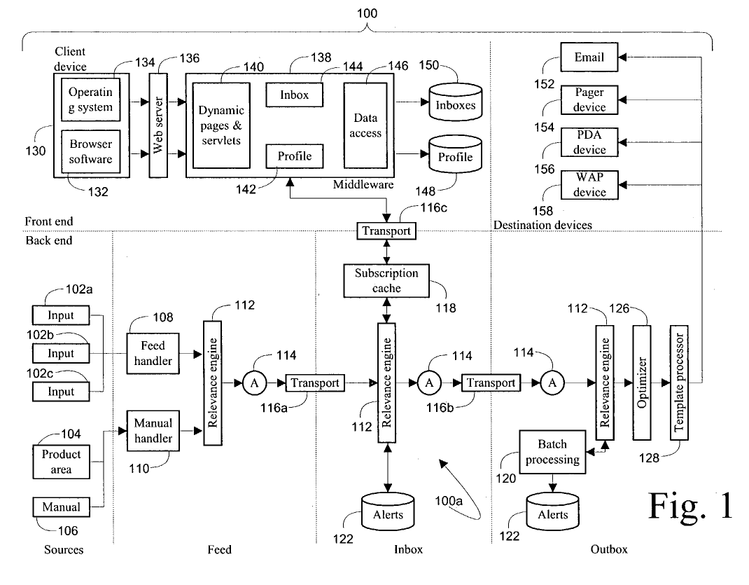

With reference to FIGS. 1 through 9, embodiments of the invention are described. FIG. 1 presents an architecture 100 to ensure timely delivery of pertinent financial data, such as account and non-account related information, to relevant clients and financial advisors. As contemplated by the present invention, financial data is encapsulated within an alert object for propagation through the architecture 100. Based on profile 148 information for a given client, a relevance engine 112 determines whether the alert should be transported to one or more output devices, e.g., a cellular telephone handset 158, a handheld computing device provided with connectivity to a data network 156, a paging device 154 or any other email enabled device 152.

Alerts are generated in response to conditions occurring within external systems 102a, 102b and 102c that provide financial data as input to the architecture 100. Online trading systems 102a managed by financial institutions are used by clients to execute trading instructions over computer networks, such as the Internet. In response to the requested action, the online trading system 102a generates informational status messages to the client. These status messages, such as open, executed, partially executed or cancelled, are provided as inputs for processing.

Research and reporting divisions that provide analysis for various securities available on the market are written to databases. Analysis data 102b, such as fixed income strategies, investment reports and other research reports are transmitted at various intervals, depending on the frequency in which the data is refreshed, as an input feed for processing. Other financial data generated by external systems 102c that are linked to the architecture of the present invention 100, such as dividend and interest calculation processes, generate data on regular intervals that must be delivered to relevant clients in a timely manner in order for prudent financial decisions to be made. These various data feeds 102a, 102b and 102c are parsed by a feed handler 108 and normalized into an alert object or data structure 114.

Product area(s) 104 generate ad hock alerts though the use of software operating within a product area pertaining to a given group of securities. The product area is provided with data files comprising accounts that hold the tracked or managed securities and is operative to generate financial information pertaining to a change in position in the product area, news regarding the product area, etc. Also, traders managing individual securities are provided with software, e.g., operating on a trading terminal, to manually generate alerts 106 to generate financial data regarding the managed security. Manually generated data and data received from product areas are parsed by a manual handler 110 and normalized into an alert data structure 114.

According to one embodiment of the invention, the alert data structure 114 is implemented as an entity java bean (EJB). The entity bean is responsible for providing an object-oriented interface to the relational database 122 used to store alerts for processing. The entity bean is provided with knowledge regarding the attributes of the alert data model. The bean may also comprise program code providing it with functionality to parse incoming data and prepare it to be entered into the database 122.

The financial data coming into the architecture 100 from the various feeds 102a, 102b, 102c, 104 and 106, is analyzed by a relevance engine 112 to ensure that clients exist that have requested the financial data comprising the feed. Where no client has requested the information, an acknowledgement is returned to the feed source and the information is discarded. The financial data is otherwise parsed into the alert object and placed on a transport queue 116 for processing by the back end inbox framework 100a. When the alert data structure is put onto the transport queue 116a and the relevance engine does not receive an exception from the transport queue 116a, processing by the feed framework is complete until additional financial data arrives from one of the feed sources 102a, 102b, 102c, 104 and 106.

The inbox framework maintained on the on the back end system 100a retrieves alert objects 114 from the inbox transport queue 116a for processing. The relevance engine 112 operating within the inbox framework 100a is concerned with determining who is interested in the alert, e.g., subscribing clients or financial advisors. Within the inbox framework, the relevance engine 112 queries a subscription cache 118 to determine all clients and financial advisors who subscribe to the alert. The results of the subscription cache query are returned to the relevance engine and an alert data store 122 is populated based on who subscribes to the alert retrieved from the inbox transport queue 116a. The alert data store 122 provides back end persistent storage of each subscriber's alerts. The relevance engine 112 records who should receive the alert, which is placed into the outbox transport queue 116b where delivery destinations are calculated and alerts are formatted for specific destination devices.

The need for fast and frequent access to subscription information is satisfied by placing frequently used items in readily available memory as opposed to maintaining it on other types of persistent storage devices that provide slower access times. The subscription cache 118 provides an efficient mechanism for storage and lookup of subscription information.

Subscription information is created when a client or financial advisor register his or her inbox and destination devices with a particular type or types of alerts that are propagated through the delivery framework of the present invention 100. The subscriptions maintained by the subscription cache 118 are a combination of subscriber-message type-account values that define whether a given inbox or device should receive information about a particular type of occurrence (alert) for a given account. Multiple processes throughout all stages of alert delivery access subscription information. For example, the feed framework is concerned with whether any subscription exists for an alert, the inbox framework needs to know which inboxes to places received alerts into and, as is explained herein, the outbox framework utilizes subscription information to determine the devices to which a given alert should be sent.

Initially, the subscription cache 118 is empty. Alternatively, the subscription cache 118 may be populated with data retrieved from an associated client account system whereby clients are subscribed by default to receive all alerts associated with any securities held in any of their accounts. When a new subscription is created, or the client or a financial advisor cancels an existing subscription, the instructions are put onto a transport queue 116c where it is retrieved and acted on according to program code executing at the subscription cache 118.

According to one embodiment of the invention, an API is employed that permits file locking and memory mapped files. Where the present invention is implemented in a Java environment, this functionality may be implemented through the use of the Java Native Interface (JNI) that provides access to platform specific functionality outside the scope of the Java Virtual Machine (JVM). Memory mapped files provide a mechanism for allowing a process to access files by directly incorporating file data into the process address space, which significantly reduces overall I/O operations. Furthermore, this configuration allows memory to be arranged in order to maximize the efficiency of lookup algorithms.

The outbox framework is operative to retrieve alert objects from the outbox transport queue 116b. The relevance engine 112 resolves a list of clients who subscribe to the alert retrieved from the outbox transport queue 116b, resolves device access information for each subscribing client, and aggregates alerts and devices if necessary. The relevance engine 112 passes alert and device information to an optimizer 126 and template processor 128 for final processing before delivery to one or more destination devices, 152, 154, 156, 158 and 116d.

For batch alert objects, the batch processor 120 is used to retrieve a list of alerts assigned to the defined batch identifier contained within the alert object 114 from the alert data store 122 and grouped according to alert type, also contained within the alert object 114. The batch processor 120, which may be a software component or a standalone application, iterates through the each message type in the alert list, aggregates alert objects by device identifiers, and transmits the objects for optimization 126, templating 128, and delivery to the destination device.

For real time alerts, the relevance engine retrieves a list of clients who subscribe to receive the particular alert. The list further comprises device information for each client that is used to deliver the alert to a destination device 152, 154, 156 158 and 116d. Alerts are grouped by their relevance according to the type of device that it is delivered to, optimized 126, examined by the template processor 128 and delivered to the destination device 152, 154, 156 and 158.

The optimizer module 126 applies a series of routines that prepare an outgoing alert to maximize the efficiency with which the transmission medium is used to carry an alert to a given destination device 152, 154, 156, 158 and 116d. For example, assume that an alert is being sent to a personal digital assistant over a slow wireless connection, such as a first generation CDMA cellular network. This transmission information is associated with the destination device in the user's profile, e.g., destination device information, and is used as an input to the optimizer, along with the financial data that comprises the alert. In response to an alert that comprises several images, the optimizer may eliminate one or more of the images in order to reduce the overall size of the alert and, therefore, the overall time and cost involved in transmitting the alert to the destination device. Similarly, where the same PDA is defined as being connected to a relatively high-speed wireless data network, such as GPRS, the optimizer with eliminate fewer images or none at all. Data regarding network connectivity provided by a destination device may be set on a device-by-device basis for each destination device operated by a user. Alternatively, transmission constraints may be defined for each class of destination devices and retrieved by the optimizer 126 based on the destination device defined in a received alert.

The template processor 128 is provides a framework for defining, storing, dynamically finding and sharing software objects that encapsulate display logic for specific devices. Essentially, the template processor is a repository of display logic objects that are dynamically applied to outgoing alerts in order to ensure the proper display of the financial data comprising the alert upon the receiving destination device 152, 154, 156, 158 and 116d. Each alert passed to the template processor 128 defines a destination device that is the alert's destination. Based on the device identifier associated with the alert, the template processor 128 calls the appropriate routine or component to modify the alert for proper display on the destination device. The alert is formatted according to the display logic of the device to which it is delivered and transmitted over a network that the destination device is in communication with, e.g., over the cellular network when the alert is delivered to a cellular telephone handset 158 operative to send and receive data according to the Wireless Access Protocol (WAP) or other wireless data transfer protocol. Exemplary destination devices include, but are not limited to email enabled devices 152, paging devices 154, handheld computing devices or PDAs 156, cellular telephone handsets 158, and other transport queues 116d.

In addition to receiving alerts on destination devices, a persistent inbox is maintained by the system through which clients may access received alerts stored at their inbox 150 through use of browser software executing on a client device 130, e.g., a personal computer. The client device stores and executes an operating system 134 that provides input and output functionality in addition to providing a framework for executing application programs. Browser software 132 is stored and executed on the client device 130 within the framework provided by the operating system 134. The browser software 132 provides the client with a means of accessing alerts in their inbox 150 that have been delivered due to the relevance of the financial data contained therein, e.g., alerts to which the client has subscribed.

Using the browser software, the client accesses the web server 136. The web server is in communication with middleware software 138 that is used to generate pages of information comprising the financial information contained within the alert that is stored in the client's inbox 150. Middleware software comprises dynamic pages and servelets 140 that generate pages of information that are specifically tailored to the client requesting the data in relation to the time at which it is requested. Inbox 144 and profile 142 data structures are instantiated on a per session basis and used to provide an interface to the inbox and profile databases, 150 and 148 respectively. Each user is provided with a view of their received alerts stored in the inbox database 150. The profile database 148 is used to maintain information regarding the client and preferences used to customize the presentation of alerts by the middleware software 138.

Servelets 140 provide interactive functionality that allows the client to perform actions regarding the alerts stored in their inbox 144, act on the data contained therein and control the user interface presented through the browser software 132. When the client logs into their inbox 144, the browser software 132 presents the client's personal alerts, which may be sorted according to any of the fields of the received alerts, e.g., according to message type, date, subject, etc. In addition to sorting controls, graphical controls are provided to filter the number and type of alerts displayed, so only alerts of a given type are presented in the inbox 144, and navigate to next and previous alerts. From the inbox 144, the client may select a message to view the alert in its entirety, e.g., when only alert headers are displayed. Furthermore, a subset of all alerts in a given inbox 144 may be selected and deleted from its storage location on the database 150.

The interface provided to the browser software allows the client to modify their profile data contained in the profile database 148. The profile module 142 is the interface and supporting subsystem that is used to manage alert delivery destinations and the type of alerts to which the client subscribes. Using functionality provided through the browser software 132, the client may subscribe to new types of alerts, cancel or update previous subscriptions, update the list of the delivery destination devices, identify parties that should be sent a copy of all received alerts (such as a client's financial advisor), and view delivery destination devices and subscriptions.

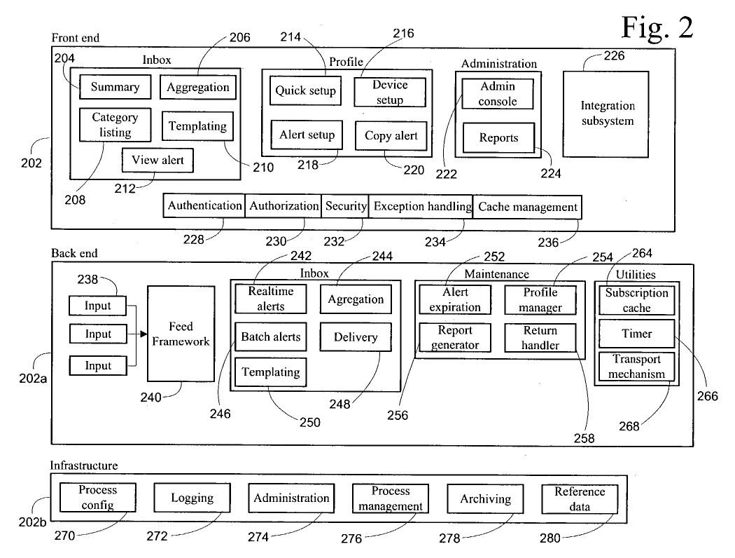

One embodiment of a logical configuration of the components that comprise the framework of the present invention illustrated in FIG. 1 is presented in FIG. 2. Users, e.g., clients, financial advisors, and system administrators, access the system through use of front-end 202 hardware and software components. Typically, the front end 202 comprises a plurality of software components executed on a personal computer or similar workstation. Users access alerts through interaction with the front-end inbox. The front-end inbox comprises software components that present alert summaries 204, aggregation of alerts 206 and organization of alerts according to the category to which given alerts belong 208. A templating component comprises display logic whereby the alert is properly displayed on the display device (not pictured) that is attached to the front-end system 202. Functionality is also provided to allow users to view detailed alert information 212, such as the financial data comprising the alert.

A profile subsystem is also provided that allows a client or financial advisors to define profile information including, but not limited to, destination devices to which alerts should be sent, the format that is used to display alerts, and alerts to which the client or financial advisor subscribes. A quick setup module 214 is provided to allow profile information to be quickly defined in order for the client or financial analyst to have immediate access to the benefits provided by the present invention. A device setup module 216 allows destination devices to be defined. An alert setup module 218 provides subscription functionality, while a copy alert module 220 allows alerts to be copied and forwarded to defined recipients.

An administration subsystem is provided, typically for use by users identified as system administrators, allows system maintenance to be performed through use of an administration console 222. According to certain embodiments, the administrator console 222 provides access to back end systems 202a, thereby allowing back end software and hardware components to be configured. The administration console 222 may be accessed through a graphical interface. Alternatively, the administrative console 222 provides a command line interface. A report generator 224 allows various reports to be generated regarding system usage by clients and financial analysts.

An integration subsystem 226 comprises various software components that allow the system of the present invention to access external systems in order to provide supplemental financial data and provides integration so the present invention may be used in conjunction with other financial systems, e.g., on-line trading systems. An authentication 228, authorization 230 and security 232 systems validate user identities and allow only valid users to access authorized portions of the system. An exception handler 234 allows errors generated by the front-end software components 202 to be caught and processed, typically without crashing or otherwise bringing down the system. A cache manager 236 allows processing of commands that modify the subscription cache.

The front end 202 is in communication with back end 202a software and hardware components that provide for processing and transport of alerts to client inboxes and destination devices. Various financial information systems 238, such as those previously described, feed financial data to the back end 202a that are used to generate alerts. A feed framework 240 processes this input 238 to initially determine if any clients or financial advisors require the alert generated by the feed framework 240. The backend inbox processes alerts. Separate functionality is provided to process both real time 242 as well as batch alerts 246. An aggregation 244 subsystem allows multiple alerts to be aggregated based on various criteria, such as a device type, by client or financial advisor, etc. A templating component 250 formats alerts according to display logic required for an alert to be properly displayed on various destination devices, which may be used in conjunction with a delivery component 248 to transmit properly formatted alerts to delivery destinations.

A maintenance system comprises components that interact with the administration console 222 and report generator 224 on the front-end system 202 to configure various aspects of the system. Exemplary administration components include program code to define when alerts should expire and be flushed from the persistent inbox 252, a profile manager 254 handles changes to user profile information and a report generator 256 compiles data to generate reports on system usage. Similarly, utilities are provided to manage the subscription cache 264, timers 266 to set alert delivery timeout thresholds and a transport mechanism 268 to provide guaranteed delivery of alerts between various front end 202 and back end 204 hardware and software components.

Working in conjunction with the front and back end hardware and software components is an infrastructure layer 202b that provides low-level functionality to the front and back end. Process configuration components 270 allow for fine-tuning and general configuration of various executing software processes of the present invention. A logging component 272 may be used to log all system activity and any errors or exceptions generated so that a developer or administrator may use to perform system maintenance. An administration component 274 provides functionality that allows other administration and maintenance processes to run effectively. A process manager 276 allows an administrator to glean information regarding executing processes, as well as to manage executing processes. An archiving component 278 is used to supply access to archival devices while reference data 280 comprises global data used by various components of the system, e.g., parameters used to initialize the system at startup.

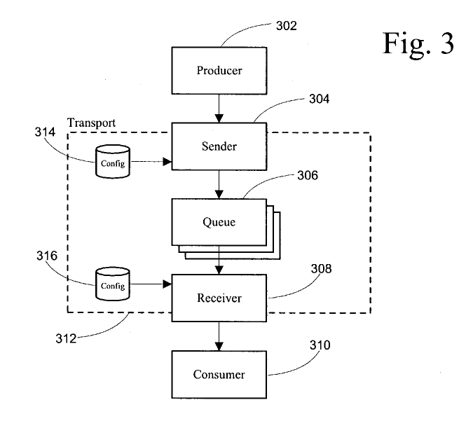

A more detailed view of the transport queues introduced in FIG. 1 is illustrated in FIG. 3, which is a block diagram presenting the components that comprise the transport queue, which may be embodied in hardware of software. The transport queue 312 is responsible for asynchronous, message-based, inter-process communication; it is intended to provide a mechanism that guarantees alert delivery and a framework for a scalable execution architecture. The transport queue 312 preferably exposes two sets of API's: one set for sending alerts and the other set for receiving alerts sent using the first API. Users of these API's are insulated from the underlying transport mechanism that provides the guaranteed message delivery. The transport queue 312 also supports transactional processing whereby a process participating in a transaction removes an alert from the transport queue 312 when the other activities comprising the transaction are successful.

On a first side of the transport queue is a producer 302. The producer 302 is a process, which may be embodied in various combinations of hardware and software components, which sends an alert object through the transport queue 312. The sender module 304 is the component through which the producer 302 interfaces with the transport queue 312. Each producer 302 is associated with an instance of a sender module 304. Each instance of the sender module 304 is capable of transmitting alert objects through as many queues 306 are required.

On a second side of the transport queue 312 is a consumer 310. The consumer 310 is a process embodied in various combinations of hardware and software components that receives an alert data structure through the transport queue 312. The receiver module 308 is the component through which the consumer 310 interfaces with the transport queue 312. Each consumer 310 is associated with one or more instances of a receiver module 308, each receiver module 308 capable of receiving messages from exactly one queue 306. This arrangement prevents processing of alert data structures by one consumer 310 from being interfered with by any other consumer. The queue 306 is the component through which the alert data structure is transported across the transport queue 312 and provides guaranteed delivery. An exemplary queue 106 is the MQSeries™ from IBM, which provides guaranteed message delivery.

Each sender 304 and receiver 308 is in communication with a configuration data store, 314 and 316, respectively, which maintain information on the queues 306 through which a producer 302 can send alert objects and from which a consumer 310 can receive alert data structures. To clarify, one example of a producer/consumer relationship is when an alert data structure is propagated from the feed framework to the inbox framework through the transport queue where the feed framework is playing the role of the producer and the inbox framework that of the consumer.

The sender module 304 operates in one of two modes: unicast and multicast. A sender 304 operating in unicast mode sends an alert data structure to only one of the queues 306 identified in the configuration data store 314, which is used for load balancing. One application of a transport queue 312 is where the volume of alerts being processed is very high, possibly requiring multiple relevance engines to handle processing. A sender 304 operating in multicast mode sends an alert to every one of the queues identified in the configuration data store 314. One exemplary application of multicast transmission is where is where an alert needs to be sent to multiple instances of a subscription cache. It is also possible to implement the sender 304 so as to operate in a mode that is a hybrid of unicast and multicast.

When a producer 302 starts up, it is associated sender module 304 is instantiated, as necessary, and initialized. During initializing, the sender 304 retrieves details regarding the queue or queues 306 that it can send alerts to from its configuration repository 314. The sender 304 sends each alert to all the queues 306 or to just one queue, depending on the mode in which the sender 304 is operating, e.g. unicast, multicast, or hybrid. The consumer 310 listening to the queue 306 through use of its receiver module 308 retrieves the alert that the sender 304 has placed onto the queue 306. According to one embodiment of the transport queue, when a sender 304 encounters an error while putting and alert onto the queue 306, the queue 306 is removed from the queue list maintained at the sender's configuration data store 314. The sender 304 refrains from putting additional alerts onto the queue 306 until a command is received instructing the sender 304 to reinstate the queue 306 into the queue list maintained at the configuration data store 314. Commands for modifying the list of queues maintained by the configuration data store 314 are sent to the producer 302 to be delegated to the sender module 304.

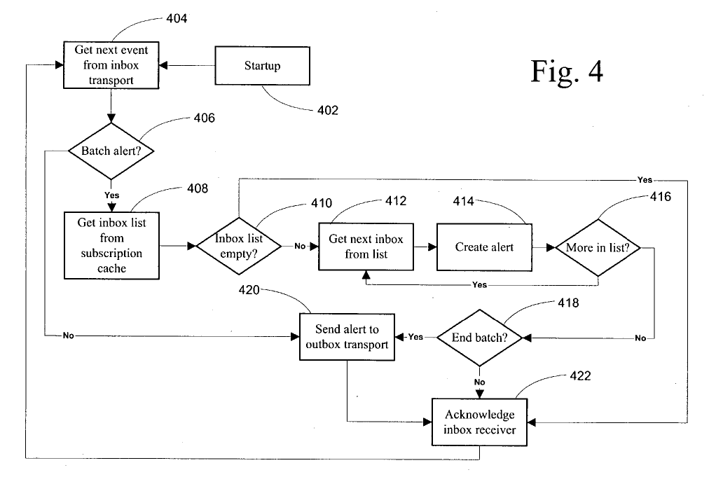

Turning to FIGS. 4 through 8, various methods of operating the system illustrated in FIGS. 1 through 3 are presented. FIG. 4 presents one embodiment of a method for operating the inbox handler framework. The inbox framework begins with startup where the framework instantiate the software components that comprise the framework, step 402. The relevance engine, within the context of the inbox framework, uses its receiver module in order to retrieve the next alert data structure from the inbox transport queue, step 404. A check is performed whereby the alert retrieved from the inbox transport queue is analyzed to determine if it is part of a batch alert for delivery to multiple client inboxes, step 406. According to one embodiment, a batch identifier or flag is set within the alert data structure to inform the relevance engine that the alert is a batch alert.

If the analysis performed by the relevance engine indicates that the alert data structure is a batch alert, step 406, a listing of inboxes maintained by the inbox framework is retrieved from the subscriptions cache, step 408. For each inbox, the inbox listing comprises the alerts to which a given client subscribes. The subscription cache may itself be a data store, such as a relational database whereby the relevance engine queries the subscription cache to determine those inboxes that subscribe to a given alert. In this manner, the inbox list is the result set generated from the query.

The relevance engine performs a check on the inbox list retrieved from the subscription cache to determine if the list is empty, e.g., whether or not an empty result set is returned, step 410. Where the inbox list retrieved from the subscription cache is empty, e.g., no clients have chosen to subscribe to the alert that is currently being processed, the relevance engine transmits an acknowledgement to its receiver module that the alert has been successfully retrieved from the queue, step 422, and the alert is discarded.

Where the inbox list retrieved by the relevance engine from the subscription cache contains a listing of inboxes for clients that subscribe to the alert being processed, step 412, an inbox identifier is retrieved from the inbox list, step 412. The financial data contained within the alert data structure is used to create an alert for delivery to the subscribing client's inbox, step 414, in addition to delivery to and delivery destination devices defined by the client's profile data. A check is performed to determine if additional inboxes are contained within the inbox list that require delivery of the alert, step 416. Where additional inboxes exist in the inbox list that have not been delivered the alert, step 416, the next inbox is retrieved from the inbox list, step 412, and relevance engine creates and delivers the alert to the retrieved inbox, step 414. The message creation process continues until all inboxes in the inbox list receive a copy of the alert and a check is performed to determine if the end of the batch has been reached, step 418.

When the relevance engine reaches the end of the batch, step 418, the alert data structure is put onto the outbox transport queue for delivery to the outbox framework, step 420. Regardless of whether the end of the batch is reached, the relevance engine transmits an acknowledgement receipt to its receiver module indicating that the alert has been successfully retrieved from the queue and processed, step 422.

Where the alert is not part of a batch of alerts, step 406, processing continues with the relevance engine passing the alert to the outbox framework for delivery to destination devices. Accordingly, the relevance engine puts the alert onto the outbox transport queue, step 420, which provides a route or pathway to the outbox framework. The relevance engine completes processing of the current alert object and issues an acknowledgment message to its receiver module instructing the module that the alert has successfully been retrieved from the queue and processed, step 422. Processing returns to step 404 where the next alert data structure awaiting processing is retrieved from the inbox transport queue.

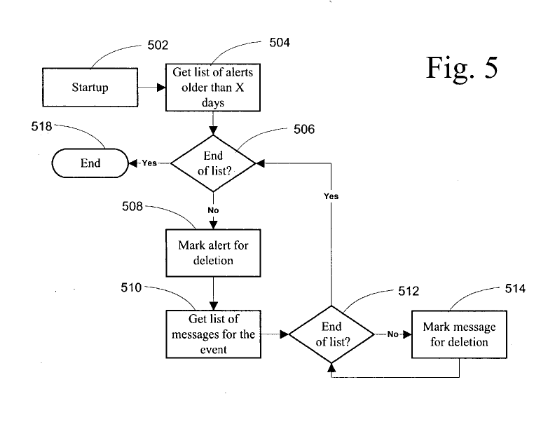

FIG. 5 presents a process for performing maintenance of a client inbox by marking for deletion all messages older than a defined threshold, which may be defined by a client or an administrator of the present system. According to one embodiment, the old messages associated with an alert are marked for removal once per day at a predetermined time, which may be implemented by a stored procedure running on the inbox data store or by other techniques well known to those of skill in the art. Alternatively, messages associated with an alert may be marked for deletion at varying times based on a user type associated with a given inbox, for example, messages in a financial advisor's inbox may be deleted at a different frequency from messages in a financial client's inbox. Furthermore, message aging and deletion may be based on the underlying alert type that forms the basis for the message.

The process begins, step 502, with the software analyzing the data store maintaining the client inboxes in order to generate a list or result set comprising a listing of messages contained within client inboxes that are older than a predetermined threshold, step 504. As discussed, this threshold may be set by an administrator or user, may be based on the underlying alert that forms the basis for the message, may be set according to the type or identity of user or user group that the inbox belongs to, or may be set according to other parameters well known to those of skill in the art.

The message list is examined to determine if the end of the list has been reached, step 506, which would be the case where the message list for messages associated with a given alert is empty. The message is marked for deletion by the software, step 508. A message associated with a given alert in a given inbox are marked for deletion, step 508, which is repeated until all messages in the given inbox associated with the alert are marked for deletion, step 506. The process ends when all the messages in the inbox that must be deleted are processed and marked for deletion, step 510.

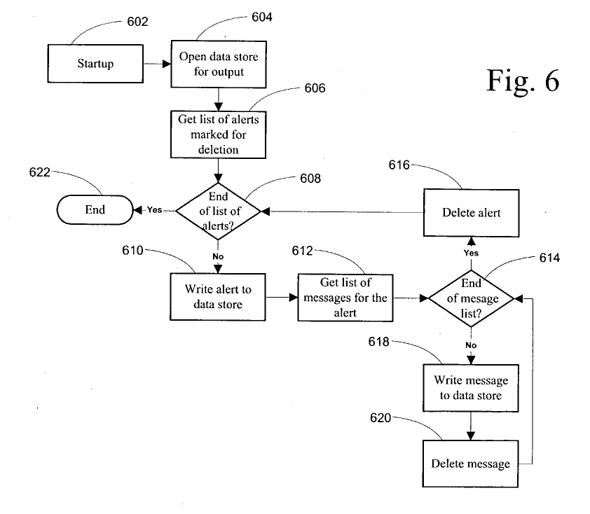

Messages that are marked for deletion due to expiration of the timing threshold according to the process of FIG. 5 may be archived for later retrieval according to the process presented in FIG. 6. When indicated by a client in their preference file, messages that are older than a predetermined threshold and have been marked for deletion are written to an archival data store and deleted by a server-side software process. The data store may be a flat file data structure, a relational database, an object oriented database or any other data storage structure well known to those of skill in the art. Archival data written to the data store is maintained for a predetermined period of time, which may be set by the client preferences or a system administrator.

The process begins, step 602, with the software accessing or opening the archival data store in order to store archival alerts and messages, step 604. Client inboxes maintained on the inbox data store are traversed to generate a list of alerts marked for deletion, step 606. According to one embodiment, the list is a result set returned from the inbox data store in response to a query from the software process responsible for performing the archiving. The software attempts to retrieve the first alert from the alert list by performing a check to determine if the end of the list has been reached, step 608, e.g., where the alert list is empty. Where additional alerts exist for processing, step 608, the archival software retrieves an alert and writes it to the data store, step 610.

For a given alert, the archival software traverses the client inbox to determine the messages that are associated with the alert and marked for deletion, step 612, which are retrieved to compile a message list. The software attempts to retrieve the first message from the message list by performing a check to determine if the end of the list has been reached, step 614, e.g., where the message list is empty. Where additional messages exist for processing, step 614, the archival software retrieves a message and writes it to the data store, step 610. The software also deletes the message from the client's inbox, step 620. The process is repeated, steps 614, 618 and 620, until all messages in the message list are processed, causing the check performed at step 614 to evaluate to false.

When all messages in the message list are archived, e.g., all messages associated with the current alert have been processed, the alert is deleted from the client's inbox, step 616. Processing returns to step 608 where the archival software evaluates the alert list to determine if additional alerts exist that require processing. Where all alerts in the alert list and associated messages are archived, the process concludes, step 622.

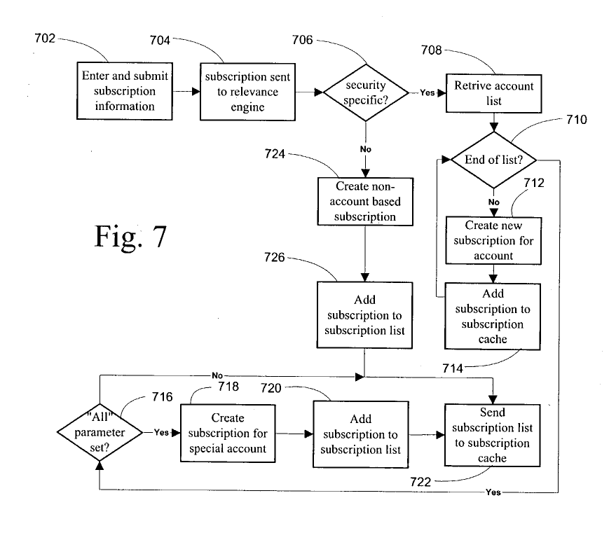

As described above, the system of the present invention provides functionality that allows a product area or individual trader to manually create alerts for delivery to clients. FIG. 7 presents one embodiment of a method whereby a client or financial advisor may subscribe to manual alerts created on an ad hoc basis. The party wishing to subscribe to the manual alert enters and submits subscription information through use of his or her computing device that is in communication with the system of the present invention, step 702. The subscription request is submitted to the relevance engine for processing and association with the account of the subscriber, step 704.

The relevance engine receives the subscription information and performs a check to determine if the subscriber is attempting to subscribe to a security specific alert, step 706. Two types of manual subscriptions are contemplated by the present invention: generic and security specific. Generic alerts do not pertain to a security whereas security specific alerts pertain to one or more securities. Where the subscription is security specific, step 706, the relevance engine retrieves the account list for the subscriber, step 708. The relevance engine performs a check to determine if the end of the subscription list has been reached, step 710, for example, where the subscriber has no accounts in the retrieved account list. A new subscription for the manual alert is created, associated with an account and entered into a subscription list, step 714. Accordingly, the subscription is associated with an account holding the security to which the alert pertains. The sub-process is looped through, steps 710, 712 and 714, until all accounts in the subscriber's account list have been processed.

When the relevance engine complete its traversal of the account list, a check is performed on the subscription to determine if an “all” flag is set by the subscriber, step 716. Where the “all” flag is set, all alerts of the security type subscribed to are sent to the subscriber irrespective of whether it pertains to any of his or her account holdings. Conversely, where the “all” flag is not set, only security specific alerts that pertain to one or more account holdings are sent to the subscriber. Where the “all” flag is set, step 716, a special account is created that does not correspond to any active account managed by the system of the present invention or by an external system interfacing with the system of the present invention, step 718. The subscription is added to the subscription list, along with any other previously entered subscriptions, and sent to the subscription cache, step 720.

Returning to the security specific check performed at step 706, where the check indicates that the subscription is generic, a non-account based subscription is generated by the relevance engine, step 724. The newly created subscription is added to the subscription list, step 726, which is sent to the subscription cache for use in determining to proper routing of alerts to client inboxes.

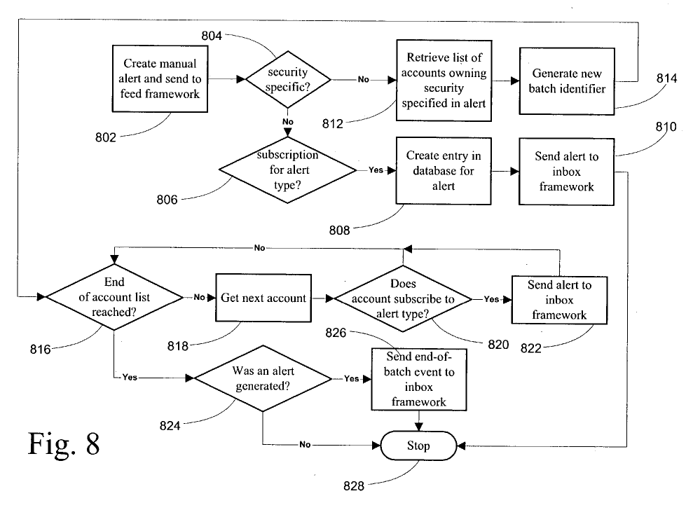

FIG. 8 presents a process for manually generating and processing alerts for distribution to subscribing clients and financial advisors in conjunction with the manual subscription process of FIG. 7. The initiating party, e.g., product group, trader or other financial analyst, creates the manual alert and transmits it over a network from the device used to create the alert to the feed framework, step 802. The feed framework normalizes the financial data from the generated alert and places it into an alert data structure, which is placed on the inbox transport queue. At the inbox framework, the relevance engine performs a check to determine if the alert data structure comprising the alert is security specific, step 804. Where the alert is determined not to be security specific, a second check is performed to determine if any client is a subscriber to the alert type identified in the alert data structure, step 806. Where both checks evaluate to false, steps 804 and 806, no client or financial advisor wishes to receive the alert and processing ends, step 828.

Where subscriptions exist for the alert type currently being processed as defined by the subscription cache, step 806, the relevance engine creates an entry for the alert in its alert database. The relevance engine sends the alert to the inboxes of all clients and financial advisors that subscribe to the alert type with which the alert is associated, step 810. The inbox framework completes its functionality vis-a-vis the alert currently being processed once the alert is placed on an outgoing transport queue and processing ends, step 828.

If the relevance engine determines that the received manual alert is security specific, step 804, as defined by information in the alert data structure that represents the alert, the relevance engine retrieves a listing that comprises all accounts that own the security identified in the alert, step 812. A new batch identifier is generated by the system and associated with the account list in order for multiple batches to be identified processed, either sequentially or in parallel, step 814.

The relevance engine performs a check on the account list to determine if the end of the account list has been reached, step 816, e.g., where the account list is empty. Typically, on the first pass of the account list, it is populated with a plurality of account entries. Where the end of the account list has not been reached, step 816, the relevance engine retrieves the next account from the account list for processing, step 818. The relevance engine compares the type contained in the received alert data structure with alert types that the current account subscribes to, step 820. Where the current account does not subscribe to the alert type defined for the alert being distributed by the relevance engine, step 820, the account list is examined to determine if the end of the account list has been reached, step 816, and retrieves the next account if available, step 818. If the current account does subscribe to the alert type of the alert currently being distributed, step 820, the relevance engine sends the alert to the inbox framework for further processing and/or delivery, step 822. The account list is again check to determine if the end of the account list has been reached, step 816, and processing continues.

When the end of the account list is reached, the check performed at step 816 evaluates to true, and a secondary check is executed to determine is an alert data structure was created, e.g., the decision block at step 816 evaluates to false at the first iteration of the loop and no alert is generated. Where an alert was indeed generated, step 824, an end-of-batch message is transmitted to the inbox framework, either over a transmission queue or other dedicated connection to the inbox framework, allowing the inbox framework to discern the end of a batch of alerts. Regardless of whether or not an alert is generated, program flow is directed to step 828 where the process concludes.

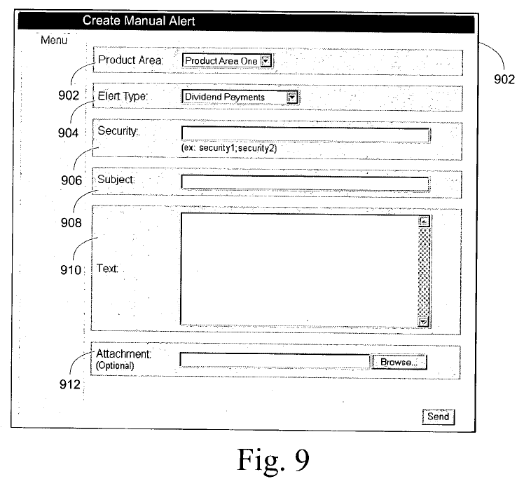

One embodiment of an interface for submitting manually alerts to the system and method of the present invention is illustrated in the screen diagram of FIG. 9. The manual alert generation interface 908 comprises a series of graphical input controls that allow the author of the alert, such as a financial analyst, to set the properties that comprise the alert. Using the product area drop-down list control 902, the alert author may associate the alert with a product area selected from the predetermined list. Alternatively, the drop down 902 may be replaced with a text entry control to allow the free form definition of product areas coupled with a server-side validation software component. An alert type drop down list control 904 is similarly provided in order to define an alert type as explained above.

The manual alert generation interface 906 further comprises a security text input control 906 where the alert author may list the symbols of the securities that the alert pertains to. For example, where the alert is regarding a condition in the semiconductor industry, the author may list relevant symbols in order for the alert to be routed to accounts that hold securities in the industry. A subject text input control 908 is similarly provided in order to provide a subject for the alert, which is followed by a text input control 910 through which the financial data comprising the alert is entered. According to embodiments of the invention, the client may configure his or her browser software to only display alert subjects when viewing the contents of their inbox, whereby selecting the subject with an input device causes the text of the message to be displayed. An attachment control 912 may be implemented in high bandwidth environments, and provided suitable client side functionality is in place, to attach additional data files to the alert for transmission to destination devices.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for processing and delivering a financial alert, the method comprising:
normalizing financial data received from one or more financial data sources to generate a financial alert;
processing the financial alert by a relevance engine according to a client profile to determine a delivery destination for the financial alert; and
delivering the financial alert to the delivery destination.

2. The method of claim 1 comprising delivering the financial alert to a persistent inbox accessed over a network.

3. The method of claim 2 comprising presenting the financial alert to a client when the persistent inbox is accessed.

4. The method of claim 1 comprising delivering a copy of the financial alert to a financial advisor.

5. The method of claim 4 comprising reviewing the financial alert to ensure conformity with regulatory compliance.

6. The method of claim 1 comprising editing the financial alert by a financial advisor.

7. The method of claim 5 comprising delivering the edited financial alert to a delivery destination.

8. The method of claim 1 comprising delivering the financial alert to a plurality of delivery destinations.

9. The method of claim 1 wherein delivering comprises delivering to one or more of a cellular telephone handset, a handheld computing device, and a paging device.

10. The method of claim 1 wherein delivering comprises delivering a summary of the financial alert.

11. The method of claim 1 comprising collecting client preference information for inclusion in the client profile.

12. The method of claim 1 comprising tracking the delivery of the financial alert to the delivery destination and calculating statistics regarding the tracked information.

13. The method of claim 1 wherein processing is based on financial transactions executed by a client.
